(19) United States
(12) Patent Application Publication
(10) Pub. No.: US 2014/0192838 A1
(43) Pub. Date: Jul. 10, 2014

(54) INNOVATIVE BEER GLASS

(71) Applicant: GARY LAWRENCE, Wayne, MI (US)

(72) Inventor: GARY LAWRENCE, Wayne, MI (US)

(21) Appl. No.: 13/735,013

(22) Filed: Jan. 6, 2013

(51) Int. Cl. G01K 13/00

(52) U.S. Cl. CPC G01K 13/00
USPC 374/141

(57) ABSTRACT

A drinking glass for beer consumption comprising: an eighteen-ounce volume; a first fill marker; a second fill marker; and a thermometer integrated into the body of the glass. In one particular embodiment, the first fill marker indicates a 16-ounce fill level and the second fill marker indicates a 4-ounce fill level. The thermometer may be positioned at the 4-ounce fill level as a indicator of the 4-ounce fill level.

### BACKGROUND OF THE INVENTION

1. Field of Invention

The present invention relates to a glass or mug that is specifically designed for consumption of beer.

2. Description of Related Art

Beer consumption is prevalent throughout the world and presently beer happens to be the third most popular drink following water and tea. Beer is manufactured through a fermentation process that creates an alcoholic beverage that is enjoyed by many individuals. Beer comes in various varieties such as pale ale, stout, lager or wheat. Beer varies in color depending on the type of brewing techniques used. Beer is sold or served in many bars and restaurants through a tap or draft style beer. This draft style beer is served from a pressurized keg and poured directly into a glass or container for consumption. Further beers are also sold in bottles and cans where many consumers drink directly from the bottle or can. The temperature of the beer served also can vary. Many consumers consume chilled beer due to the refreshing nature associated with chilled beer. However purists may prefer their beer slightly warmer especially when consuming some of the darker lagers, stouts or ales. Serving temperatures for beer can vary from 45 degrees Fahrenheit up to room temperature at about 60 degrees.

The typical glass that is used for serving beer is a 16-ounce pint. Many bars and restaurants served pints in glasses that actually do not hold 16 ounces of liquid. Even when using a true pint many times beer is poured without a head in order to maximize the volume of liquid in the glass. The drawback to pouring beer without a head is that pouring beer with the head releases flavors and aromas, therefore beer without the head lacks these flavors and aromas that were being released.

Consequently, it would be advantageous to have a beer glass that allows for the server to pour a true 16-ounce pint of beer with a suitable head. Further it would be advantageous for the consumer to have a temperature gage integrated within the glass as a means to measure the temperature of the beer within the glass.

### SUMMARY OF THE INVENTION

The present invention relates to a drinking glass for beer consumption comprising: an eighteen-ounce volume; a first fill marker; a second fill marker; and a thermometer integrated into the body of the glass. In one particular embodiment, the first fill marker indicates a 16-ounce fill level and the second fill marker indicates a 4-ounce fill level. The thermometer may be positioned at the 4-ounce fill level as a indicator of the 4-ounce fill level.

### BRIEF DESCRIPTION OF DRAWINGS

FIG. 1 depicts a beer glass in accordance with the present invention.

### DETAILED DESCRIPTION

The present invention relates to a beer glass designed specifically for beer consumption. The beer glass in accordance with the present invention includes a thermometer integrated within the glass provides the means for the consumer to monitor the temperature of the beer. Further the thermometer is placed at the 4-ounce mark of the glass in order to provide a convenient marking for a sample size. Further the beer glass according to the present invention is an 18-ounce glass that has a marker to allow for a head to be poured with the beer. The glass according the present invention therefore enables the server to release the flavors and aromas by providing an adequate head and keeps the consumer informed as to the temperature of the beer as its being consumed.

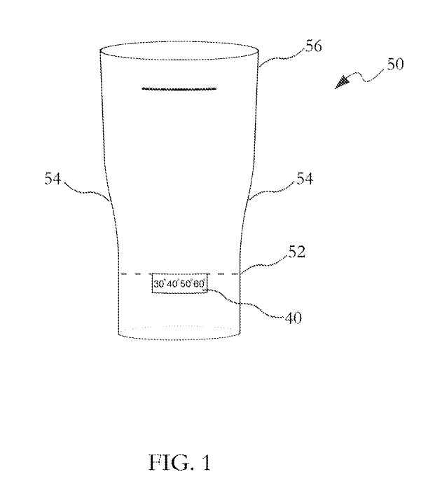

In reference to FIG. 1, a beer glass 50 in accordance with the present invention is depicted. The beer glass 50 holds 18 fluid ounces. The beer glass 50 includes a 16-ounce fill marker 56 that indicates a 16-ounce level for the beer. This fill marker 56 ensures that the server may provide a head of about 2 ounces of foam so that the complete flavor and aroma of the beer is provided for the consumer. Further by providing the extra 2 ounces the consumer receives a full pint of fluid beer with each pour. Provided at the midpoint of the glass is a slight bend 54. The slight bend 54 is principally provided for comfort and gripping purposes for the consumer. Also provided in the beer glass 50 is a thermometer that is integrated into the wall of the glass as shown with thermometer 40. A thermometer 40 is placed at a 4 ounce marking point 52. So the thermometer provides a clear indicator of the temperature of the beer within the glass. Further it is placed at a level, 4 ounces, so that the glass may be also utilized for sampling purposes in addition to a full pour of consumption.

The beer glass 50 is configured to provide a complete beer glass for the discerning beer consumer. Beer may be poured at optimal temperatures and an ability to monitor temperature by using the thermometer provided on the glass. Further the consumer may also allow the beer to warm to room temperature if necessary to enjoy consuming some of the darker stouts that provide greater favor at these slightly higher temperatures. The beer glass 50 according to the present invention may be manufactured of typical glass used for any drinking glass provided on the market. However its unique design and particular markings provide for optimum use for the beer consumer. The instant invention has been shown and described in what it considers to be the most practical and preferred embodiments. It is recognized, however, that departures may be made there from within the scope of the invention and that obvious modifications will occur to a person skilled in the art.

What is claimed is:

1. A drinking glass for beer consumption comprising:
a. an eighteen ounce volume;
b. a first fill marker;
c. a second fill marker; and
d. a thermometer integrated into the body of the glass.

2. The drinking glass according to claim 1, where the first fill marker indicates a 16-ounce fill level.

3. The drinking glass according to claim 1, where the second fill marker indicates a 4-ounce fill level.

4. The drinking glass according to claim 3, where the thermometer is positioned at the 4-ounce fill level.
